(19) United States
(12) Patent Application Publication
(10) Pub. No.: US 2004/0261270 A1
(43) Pub. Date: Dec. 30, 2004

(54) Shaving apparatus with radio

(76) Inventor: Narain Daryanani, Kowloon (HK)

Correspondence Address: VEDDER PRICE KAUFMAN & KAMMHOLZ, 222 N. LASALLE STREET, CHICAGO, IL, 60601, US

(21) Appl. No.: 10/685,283

(22) Filed: Oct. 14, 2003

Related U.S. Application Data
(60) Provisional application No. 60/482,840, filed on Jun. 26, 2003.

(51) Int. Cl. B26B 19/00

(52) U.S. Cl. 30/34.05

(57) ABSTRACT

The handle of a razor is provided with a single-chip radio receiver, controls, battery, antenna and an audio transducer, such as a speaker or a piezoelectric annunciator by which a person can listen to broadcast radio channels while shaving. A waterproof speaker, waterproof controls and a waterproof housing make the shaving apparatus with a radio immersible. By using a small processor with memory instead of a radio IC and an audio transducer, the shaving apparatus can play back pre-recorded audio or, record audio from the audio transducer for later playback to the audio transducer.

### FIELD OF INVENTION

The present invention generally relates to an audio shaving razor and, more particularly, to a system capable of incorporating a radio circuit into a shaving razor using a waterproof plastic housing and a waterproof speaker means.

### BACKGROUND OF THE INVENTION

Shaving razors have been manufactured for years. Some shaving razors are manufactured so inexpensively that they are disposable.

Improvements in semiconductor technology have made possible integrated circuits that contain virtually all of the electronics for a broadcast radio receiver. It is now possible to place virtually all of the circuitry of an AM, FM or AM/FM radio on a single integrated circuit substrate. The commercial success of light-weight transistorized radios have lead to the development of various electronic radio combinations such as the electronic radio/alarm clock.

An object of this invention is therefore to provide an improved shaving razor with the ability to receive broadcast radio and render the broadcast programming as audio from a speaker.

Another object of this invention is to provide an improved shaving razor with a radio enclosed within a waterproof housing.

Yet another object of this invention is to provide an improved shaving razor to which a radio can be readily attached and detached.

### BRIEF DESCRIPTION OF THE DRAWINGS

The present invention and the advantages and features provided thereby, will be best understood upon review of the following detailed description of the invention, taken in conjunction with the following drawings, where like numerals represent like elements, in which:

FIG. 1 is a schematic diagram of the front of a shaving apparatus incorporating a radio circuit, controls, speaker, an antenna and a battery.

FIG. 2 is a side elevation of a shaving apparatus incorporating a radio circuit, controls, a speaker, an antenna and a battery.

FIG. 3 is a schematic diagram of broadcast radio receiver implemented using an integrated circuit (IC).

FIG. 4 is a schematic circuit diagram of an alternate embodiment of a shaving apparatus to which a radio can be attached and from which the radio can be detached.

### DETAILED DESCRIPTION OF THE PREFERRED EMBODIMENTS

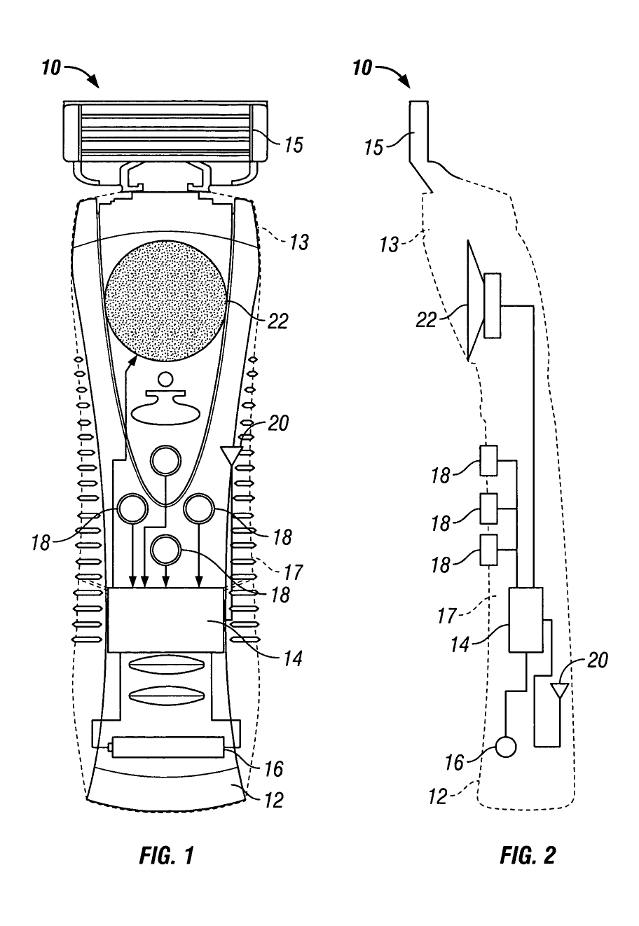

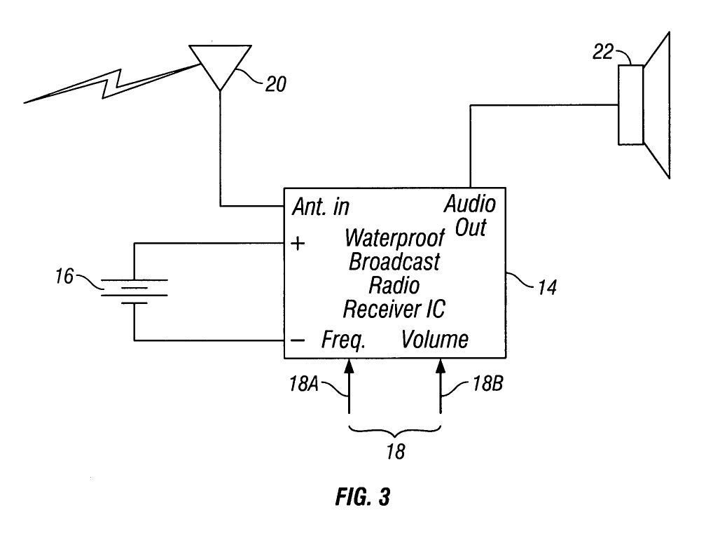

With references to FIGS. 1 and 2, a battery-powered radio 10 is provided by a plastic shaving handle 12, a first end 13 of which carries a shaving head 15 capable of carrying one or more razor blades commonly used for hair removal. In one embodiment, the shaving head 15 carries disposable razor blade assemblies, well-known in the disposable razor art.

In the preferred embodiment, the plastic handle 12 encloses a waterproof volume 17 in which electronic components such as one or more active devices and one or more passive devices can be connected together and mounted. The enclosed volume 17 is made waterproof by appropriate gaskets and/or seals between mating surfaces of the plastic handle 12.

The electronic components encased in the waterproof plastic housing 17 include a radio receiver integrated circuit (IC) 14 as well as ancillary passive devices that are, or might be required by the IC 14, can be mounted inside the waterproof plastic housing 17. Adjustment and operation of IC 14, i.e., radio tuning and audio output level adjustment can be accomplished using waterproof controls 18 that are accessible from at least one side or face of the shaver handle 12 as shown in FIGS. 1 and 2. By appropriate connections between the waterproof controls 18 and the IC 14, the waterproof controls 18 can be used to change a received frequency, change the audio output volume from an audio transducer such as a speaker. Examples of waterproof controls 18 would include a waterproof potentiometer, waterproof switches and waterproof variable capacitors and inductors. In one alternate embodiment, fixed-value capacitance is used whereby the radio IC 14 is always tuned to a single radio frequency. An embodiment wherein a radio is tuned to a single frequency finds application where the single frequency is a public safety channel, e.g., the weather service, or as a promotional item for a particular radio station.

In embodiments where the IC 14 is capable of receiving both AM and FM frequency bands, a particular band can be selected using a handle-mounted waterproof switch to select between different frequency bands. Those of ordinary skill will appreciate that the functionality of the controls 18 must therefore extend into and connect to control inputs of the IC 14 enclosed in the waterproof volume 17 of the plastic handle 12.

A waterproof volume control is used to adjust the audio output volume from the waterproof speaker 22; a waterproof tuner is embodied as either a waterproof fixed or variable capacitance or a waterproof voltage-controlled oscillator or VCO.

The handle also encloses a battery 16 in either the same waterproof compartment 17 as the IC or its own separate waterproof compartment. Inasmuch as the battery 16 can be depleted of energy, its periodic replacement is enabled by mounting the battery 16 in a recloseable, separate waterproof compartment, accessible from the handle's 12 exterior.

For purposes of claim construction, the term “waterproof” should be understood to mean capable of withstanding water infiltration when the shaver 10 is immersed in water depths commonly found in the home. In other words, a “waterproof” compartment will admit no water when the shaver is immersed in water, to a depth of 12-18 inches. Waterproof should also be understood to mean that the radio can be operated under water as well. Therefore, a “waterproof” shaver radio includes a waterproof speaker that is a speaker that is either capable of operating underwater or is enclosed within a waterproof yet sound-transmissive compartment. At least one speaker embodiment was rubberized.

A single-chip FM band broadcast radio receiver IC is manufactured by and available from Phillips Semiconductors (See e.g., http://www.phillipssemiconductors.com). This device is identified by the Phillips part number TDA7088T. Phillips previously manufactured a single-chip AM band broadcast radio receiver identified by the Phillips part no. TEA5551 T but has discontinued the manufacture of a single-chip AM radio.

The FM radio IC TDA7088T is available in an S016 package. The IC can be powered from voltage sources as low as 1.8 volts and search tuned using a single varicap diode. Devices like the TDA7088T and TEA555 IT are small and readily enclosed within the handle of a shaver.

The handle depicted in FIGS. 1 and 2 is shown with a substantially rectangular cross section and sized to accommodate ancillary devices for the single chip radio IC 14. Alternate and equivalent embodiments of the shaver include handles with circular or elliptical cross-sections as well.

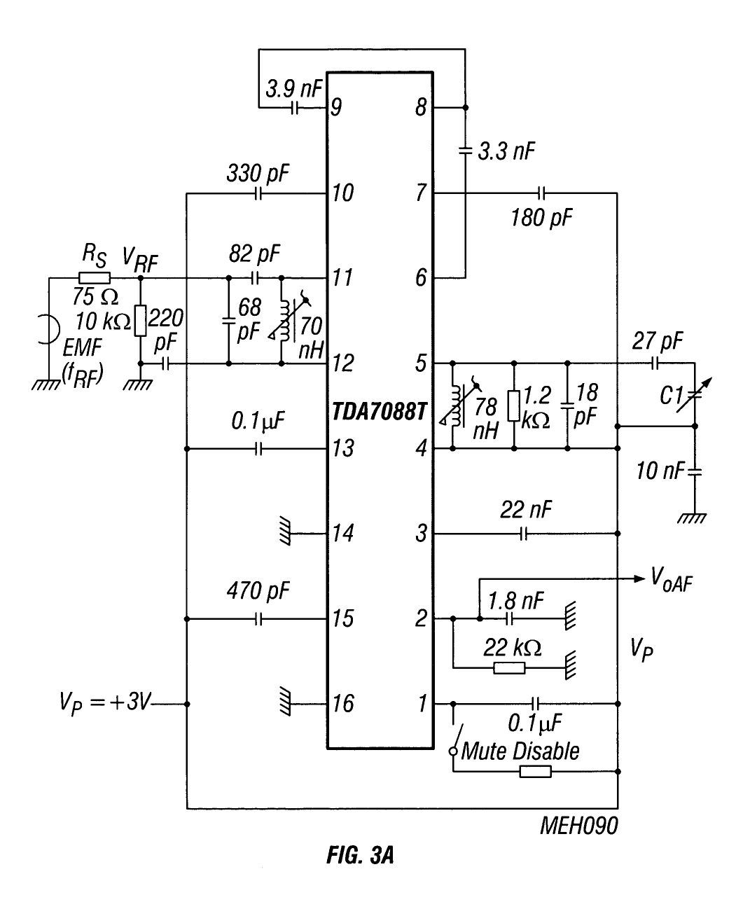

FIG. 3 depicts external circuitry required to enable a single chip radio such as the aforementioned TDA7088T FM radio IC 14 operate. In particular, RF signals picked up by the antenna 20 are coupled to the RF input pins 11 and 12 of the device. Audio output from the TDA7088T device appears on pin 2. In one embodiment, the audio signals output from pin 2 are coupled to a waterproof speaker (not shown in FIG. 3). A varicap diode coupled to pin 15 enables the TDA7088T device to be tuned.

Complete implementation details for the TDA7088T single-chip FM radio receiver IC 14 are available from the application notes published by Phillips Semiconductors and downloadable from the aforementioned Phillips Semiconductors web site.

A waterproof speaker and a waterproof plastic housing enable a user to rinse the razor under water. A waterproof volume control enables a user to adjust the level of the speaker output. In another embodiment of the present invention, the audio shaving razor will include an auto scan function to search for radio stations automatically. In yet another embodiment of the present invention, fixed capacitances can be used to tune the radio to a single channel. A display of the frequency, band and volume can be provided by using an LED or LCD display (not shown) in the handle 12. By utilizing a waterproof, transparent window to view an LED or LCD display, the shaver can display the radio station being monitored.

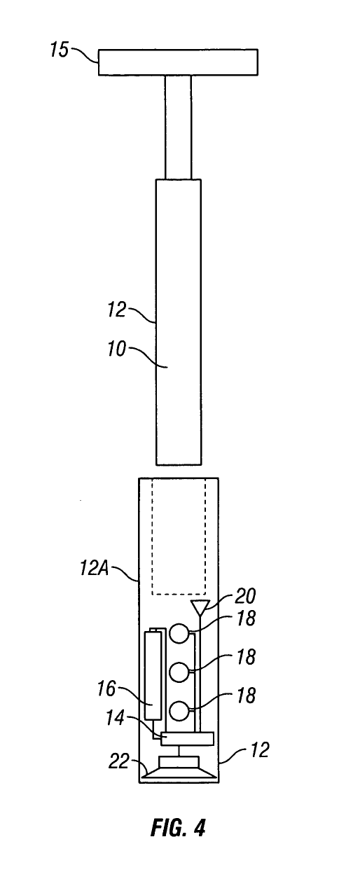

FIG. 4 is an alternate embodiment of the shaving razor 10 wherein a portable razor 10 has a disposable shaving head 15 attached to on end of a plastic handle 12. The opposite or second end of the handle 12 has a connector (not shown) that detachably couples to a portable broadcast radio receiver handle attachment 12A.

The embodiment depicted in FIG. 4 provides the functionality of the previously-described embodiments, including a radio receiver IC 14, a speaker 22, a battery 16 and controls 18, however, by making the radio detachable, the IC, speaker 22 and controls 18 need not be waterproof. A translucent window (not shown) over a display LED or LCD can also provide information to an operator.

By making the radio receiver handle attachment 12A detachable from the shaver handle 12, the handle 12 and the shaving head 15 can be separated from electronic components that should not get wet. By detaching the handle 12 from the attachment 12A, parts that require cleaning can be immersed with less likelihood of damaging electronic components in the attachment 12A. The battery 16 can also be specified to be rechargeable so that it need not be housed in a resealable, waterproof compartment in the handle attachment 12A.

In yet another embodiment, the shaving razor depicted in the figures can be made to play pre-stored music, synthesized or digitized speech or other audio from the speaker or another type of audio transducer, such as a piezoelectric audio transducer. By replacing the IC 14 with an appropriately-capable processor and memory, music, speech or other audio program content can be reproduced from data stored in memory output from the audio transducer 22.

Those of ordinary skill in the computer programming and semiconductor arts know that single-chip microprocessors have been available for years that include read only memory in which both program instructions and data representing audio can be stored (e.g., the Intel 8051 and Motorola 68HC11-families of microcontrollers). By replacing the aforementioned radio IC 14 with a suitably-capable processor 14, a stream of data output from the processor is converted to an analog signal. Music, speech or other audio can be digitized, stored in the processor or ancillary memory and read out (played back) through the audio transducer 22.

In yet another embodiment, the shaving razor can also be used to record and playback audio signals. By programming the aforementioned microcontroller/processor 14, it digitizes analog signals picked up by the audio transducer and stores the data into memory. The data stored in memory can be read out and used to reconstruct, i.e., playback the audio that was previously picked up by the transducer 22, converted to a digital form by the processor 14 and stored as data.

Single-chip voice recorders are readily available from Winbond Electronics Corporation of America, 2727 North First Street, San Jose, Calif., 95134. (See www.isd.com.) As of the filing date of this application, the Winbond ISD5008 single chip recorder is capable of storing up to eight (8) minutes of audio. Other devices from Winbond have shorter as well as longer recording times.

In light of the foregoing, a shaving razor can be provided with audio capability in the form of broadcast radio reception, pre-recorded audio or recorded audio. Promotional shavers with radios embedded into the handle can be user tuned or pre-tuned to a particular radio station as a promotional item. By replacing the radio IC 14 with a single chip recorder, promotional music or other audio content can be stored and played back from the razor.

What is claimed is:

1. A shaving razor comprising:
a shaving handle having a first end to which said shaving head is attached, said handle enclosing a first volume in which electronic components can be located and from which said electronic components can be operated; and
at least one radio integrated circuit (radio IC) enclosed within the first volume, said radio IC having an RF input for coupling to an antenna, a power input terminal for coupling to a power source, a ground input, a control input for coupling the radio IC to a tuning device for the radio IC and, at least one audio output port from which audio signals output from the radio IC can be coupled to an audio transducer.

2. The shaver of claim 1 further including a shaving head that has at least one razor blade, said shaving head being attached to a first end of said handle.

3. The shaver of claim 1 wherein said handle encloses said first volume and said volume is waterproof.

4. The shaver of claim 1 wherein said at least one radio integrated circuit includes at least one of: 1) a broadcast AM-frequency band radio receiver IC and, 2) an FM frequency band radio receiver IC.

5. The shaver of claim 1 further including an audio transducer coupled to said audio output port of said radio IC.

6. The shaver of claim 5 wherein said audio transducer is a speaker.

7. The shaver of claim 6 wherein said speaker is substantially waterproof.

8. The shaver of claim 6 wherein said speaker is rubberized.

9. The shaver of claim 1 wherein said handle includes waterproof controls for said radio IC.

10. The shaver of claim 1 further including a waterproof tuner for said radio IC.

11. The shaver of claim 10 wherein said waterproof tuner is a capacitance.

12. The shaver of claim 10 wherein said waterproof tuner is an inductance.

13. The shaver of claim 1 wherein said handle has a substantially circular cross section.

14. The shaver of claim 1 wherein said handle has a substantially rectangular cross section.

15. A shaving razor comprising:
a shaving head;
a handle having a first end to which said shaving head is attached and having a second end opposite said first end; and
a portable broadcast radio receiver, detachably coupled to said second end of said handle.

16. The shaver of claim 15 wherein said portable broadcast radio receiver is substantially waterproof.

17. The shaver of claim 15 further including a waterproof speaker coupled to said portable broadcast radio receiver.

19. The shaver of claim 15 wherein said portable broadcast radio receiver includes waterproof controls.

20. The shaver of claim 15 wherein said handle has a rectangular cross section.

21. A shaving razor comprising:
a shaving head;
a handle to which said shaving head is attached; and
a portable broadcast radio receiver, enclosed with said handle.

22. A shaving razor with audio, comprising:
a razor having a handle;
a waterproof plastic housing within said handle;
a waterproof speaker mounted within said waterproof plastic housing; and
a radio circuit contained within the waterproof plastic housing and coupled to said waterproof speaker.

23. A shaving razor with audio, comprising:
a razor having a handle;
a waterproof housing within said handle;
a waterproof audio transducer within said handle;
at least one integrated circuit contained within the waterproof plastic housing, said integrated circuit including a processor that is coupled to said audio transducer, said integrated circuit storing computer program instructions and data, which when said instructions are executed by the processor, cause the processor to output a predetermined audio signal from said audio transducer; and
a battery coupled to said at least one integrated circuit.

24. The shaving razor of claim 23 wherein said integrated circuit stores computer program instructions and data, which when said instructions are executed by the processor, cause the processor to output from said audio transducer, a sequence of musical notes.

25. The shaving razor of claim 23 wherein said integrated circuit stores computer program instructions and data, which when said instructions are executed by the processor, cause the processor to output synthesized speech.

26. A shaving razor with audio, comprising:
a razor having a handle;
a waterproof housing within said handle;
a waterproof audio transducer within said handle;
at least one integrated circuit contained within the waterproof plastic housing, said integrated circuit including a processor that is coupled to said audio transducer, said integrated circuit storing computer program instructions and data, which when said instructions are executed by the processor, cause the processor to convert analog voltages from said audio transducer into data and store said data into memory; and
a battery coupled to said at least one integrated circuit.

27. The shaving razor of claim 26 wherein said integrated circuit stores computer program instructions and data, which when said instructions are executed by the processor, cause the processor to read said data from memory, and re-construct an analog signal from said data and output the analog signal to said audio transducer.
